(19) United States
(12) Patent Application Publication
(10) Pub. No.: US 2009/0316553 A1
(43) Pub. Date: Dec. 24, 2009

(54) TAPE CONDITION IN A TAPE DATA TRANSFER APPARATUS

(76) Inventors: Russell Ian Monk, Caldicot (GB); Nigel Ronald Evans, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/485,737

(22) Filed: Jun. 16, 2009

(30) Foreign Application Priority Data
Jun. 18, 2008 (GB) 0811142.9

(51) Int. Cl. G11B 20/18

(52) U.S. Cl. 369/53.41; G9B/20.046

(57) ABSTRACT

A tape data transfer apparatus operable to determine a tape damage condition of a tape received in the apparatus by determining a value representative of a tape pack size of the received tape and comparing the value representative of tape pack size with a tape pack size reference value that is read from the cartridge.

### CROSS REFERENCES TO RELATED APPLICATIONS

This application claims the benefit of United Kingdom Patent Application No 0811142.9, filed Jun. 18, 2008, the content of which is incorporated by reference in its entirety.

### BACKGROUND OF THE INVENTION

Tape, such as magnetic and optical tape, is a known medium for storing data. Tape is, for example, widely used for computer data storage in tape back-up systems and tape libraries. The tape may be supplied in a tape cartridge comprising a casing that houses one or more reels. In tape cartridges with two reels, respective ends of the tape are connected to the reels such that the tape can be spooled back and forth between the reels to allow access along the length of the tape for writing data to and reading data from the tape (collectively ‘data transfer operations’). The reels are each configured to be engaged by respective rotatable reel engaging members of a data transfer apparatus such that the reel engaging members can serve as rotatable axles for the reels. In data transfer apparatus that uses tape cartridges having just one reel, a reel is provided in the data transfer apparatus to which a free end of the tape is connected to permit spooling.

In use, the tape is repeatedly spooled back and forth at high speeds to allow access along the length of the tape for data transfer operations. During the course of these repeated spooling movements, the tape, and particularly the edges of the tape, may be damaged. This may be the result of contact with the tape guides and/or read-write head, which devices often include flanges or a ledge for restricting lateral movement of the tape in one or more directions by engagement with one or both edges of the tape.

Damage to the tape edges is difficult to detect since it often does not affect the data areas of the tape until a critical condition is reached. The eventual failure may be a snapped tape, an excessive amount of tape debris spreading around the tape itself and the tape drive (resulting in head-tape spacing), tape delamination and excessive reel (tape pack) friction causing tension changes or completely stuck reel conditions.

A partial solution to the problem of the accumulation of debris has been to provide a blade to scrape debris from the tape. This may be effective in reducing head-tape spacing problems, but is not effective in preventing tape snaps and reel stuck conditions.

Another partial solution has been to detect critical error conditions when they occur. For example, a stuck reel may be detected, but by the time this happens, tape failure may be unavoidable.

Another partial solution has been to detect changes in reel friction by means of a tape sensor contacting the tape. However, this is costly and presents tape-handling problems.

When a tape edge is damaged, the tape loses its planar characteristic due to deformation of the tape edges. When packed on a cartridge reel this results in air being trapped between successive layers of the tape. This phenomenon increases in severity with wider tapes, lower tape tension and higher tape speeds, since each of these factors increases the difficulty of expelling air when winding the tape. The resultant low pack hardness is not usually detected until it becomes so bad that the tape layers start slipping (either axially or circumferentially) and when that happens tape failure is imminent. This problem can be addressed by providing a roller positioned in the tape cartridge to press against the tape reel. However, this adds to the complexity and expense of the cartridge.

If not dealt with in some way, all of these problems are either extremely difficult or impossible to recover from and can lead to loss of data.

### BRIEF DESCRIPTION OF THE DRAWINGS

In order that the invention may be well understood, some embodiments thereof, which are given by way of example only will now be described with reference to the drawings in which:

FIG. 1 is a perspective view from above of a tape cartridge;

FIG. 2 is perspective view from below of the tape cartridge of FIG. 1;

FIG. 3 is a schematic diagram showing selected elements of a tape drive together with a tape cartridge with the magnetic tape from the tape cartridge in a deployed condition;

FIG. 4 is a schematic diagram showing elements of a tape driving system of the tape drive of FIG. 3;

FIG. 5 is a flow diagram illustrating a procedure for determining a tape pack total area as a reference value; and

FIG. 6 is a flow diagram illustrating a procedure for determining a damage condition of a magnetic tape.

### DETAILED DESCRIPTION

The embodiments described below relate to digital data transfer apparatus based on the DAT technology for operation in accordance with any known format including the DDS4, DAT 72 and DAT 160 formats. However, it will be understood that that the principles described are applicable to tape data transfer apparatus generally and that the description of the embodiments should not be taken as limiting. In the description that follows, the digital data transfer apparatus will be referred to as a tape drive.

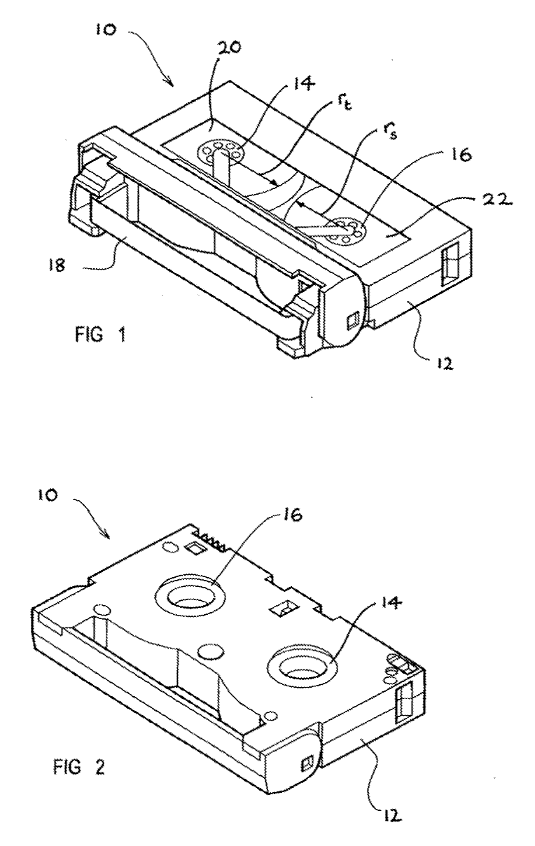

Referring to FIGS. 1 and 2, a tape cartridge 10 comprises a casing 12 that houses a take up reel 14 and a supply reel 16. It will be appreciated that the terms ‘take up’ and ‘supply’ are conventional descriptors given to the reels and that in use, the operation of each reel (ie take up/supply) changes according to the direction in which the reels are rotating.

A tape 18 has respective ends connected to the reels 14, 16 such that it can be spooled back and forth between the two reels to allow access along its length for data transfer operations. The tape 18 is wound onto the two reels 14, 16 to form respective tape packs 20, 22. The radius rₜ of the tape pack 20 wound onto the take up reel 14 and the radius rₛ of the tape pack 22 wound onto the supply reel 16 each vary continuously as the tape is spooled between the two reels.

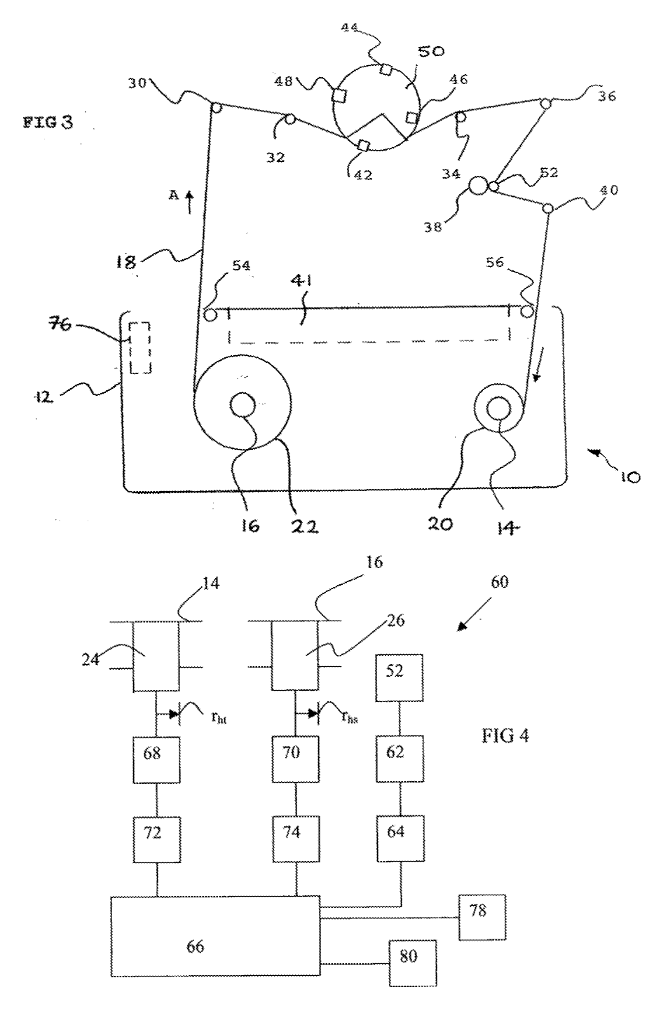

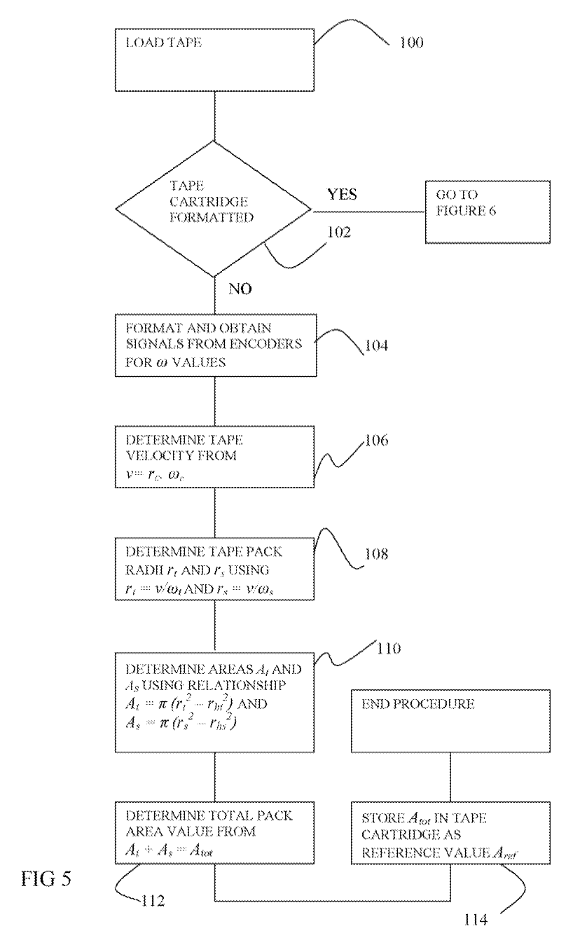

As shown in FIG. 2, the underside of the cartridge casing 12 is provided with respective apertures that allow access to the take up reel 14 and supply reel 16. The take up reel 14 and supply reel 16 are configured to be engageable by respective rotatable tape reel engaging members in the form of tape drive spindles 24, 26 (FIG. 4) by means of which the two reels are driven when the tape 18 is moved back and forth between the reels.

Referring to FIG. 3, the tape cartridge 10 is illustrated loaded in a tape drive with the tape 18 fully deployed for data transfer operations. The tape drive includes tape guides 30, 32, 34, 36, 38, 40. In a known manner, the tape guides 30, 32, 34, 36, 38, 40 are movable from locations within an access area 41 (broken lines) in the casing 12 to the locations shown in FIG. 3 so as to deploy the tape 18. In this deployed position, the magnetic tape 18 contacts the heads 42, 44, 46, 48 of a rotatable tape head drum 50 as the tape is drawn past the rotating drum in the direction of arrow A. One of the guides 38 is a pinch roller that presses the tape 18 into contact with a capstan 52 for controlling the passage of the tape past the drum 50. Guide posts 54, 56 of the tape cartridge 10 are fixed in the casing 12. The tape 18 is supported by the guide posts 54, 56 when in its fully retracted position inside the casing 12.

Referring to FIG. 4, a tape driving system 60 of the tape drive comprises an electric motor 62 that is coupled to the capstan 52 for rotatably driving the capstan. An encoder 64 associated with the electric motor 62 outputs a pulsed signal indicative of the speed of rotation of the capstan 52. The pulsed signal from the encoder 64 is fed to a processor 66. The tape driving system 60 additionally comprises the tape drive spindles 24, 26 and respective electric motors 68, 70 coupled to the tape drive spindles for driving the tape drive spindles. Respective encoders 72, 74 associated with the electric motors 68, 70 output pulsed signals indicative of the speed of rotation of the tape drive spindles 24, 26. The pulsed signals from the encoders 68, 70 are fed to the processor 66. Although not described, the tape driving system 60 may comprise suitable circuitry and/or devices between the encoders 64, 72, 74 for conditioning the signals fed to the processor 66.

The processor 66 has access to a stored value that is representative of a radially extending dimension of the capstan 52, which may be the diameter d_{c} or radius r_{c}. For convenience in the description that follows, the value will be referred to as the radius r_{c}. The radius r_{c} may, for example, be stored in a ROM 78 that is a part of the tape drive. The processor 66 is operable to use the stored radius r_{c} value together with signals from the encoders 64, 72, 74 to determine a damage condition of the tape 18. Specifically, the processor makes use of the relationship

v=r·ω

where

v=velocity

r=radius

ω=rotational speed

to determine values representative of the radius rₜ of the tape pack 20 on the take up reel 14 and the radius rₛ of the tape pack 22 on the supply reel 16. Again, for convenience, in the description that follows, these values will simply be referred to as the radius rₜ and the radius rₛ. The first stage in the process of determining the radii rₜ,rₛ is to determine the velocity v of the tape 18. Since the processor 66 has access to the stored value of the radius r_{c} of the capstan 52 and can derive a rotational speed value ω_{c} of the capstan from the signals received from the encoder 64, it is able to determine a value representative of the velocity v of the tape passing from the capstan using the relationship

v=ω_{c}·r_{c}

Taking the case illustrated in FIG. 3 in which the tape 18 is spooling from the supply reel 16 to the take up reel 14, for practical purposes, the tape leaving the tape pack 22 on the supply reel 16 will be moving at the same velocity v as the tape joining the tape pack 20 on the take up reel 14. Since the processor 66 is able to determine a value representative of the velocity v and determine values representative of the rotational speeds ωₜ and ωₛ of the tape drive spindles 24, 26 (which in use rotate at the same speed as the respective tape reels 14, 16) from the signals received from the encoders 72, 74, it is able to determine a value representative of the radius rₜ of the tape pack 20 and a value representative of the value of the radius rₛ of the tape pack 22 from the relationships

v/ωₜ=rₜ

and

v/ωₛ=rₛ

It will be appreciated that the values rₛ and rₜ can be determined without determining the value v. Specifically, the relationships

rₜ=ω_{c}·r_{c}/ωₜ

and

rₛ=ω_{c}·r_{c}/ωₛ

can be used.

Using the radius values rₜ and rₛ, the processor 66 is able to determine the respective values representative of areas Aₜ and Aₛ of the tape packs 20, 22 on the take up reel 14 and supply reel 16 from the relationships

Aₜ=π(rₜ²−rₕₜ²)

and

Aₛ=π(rₛ²−rₕₛ²)

where rₕₜ and rₕₛ (FIG. 4) are values representative of the radii of the respective hub portions of the tape reels 14, 16 about which the tape packs 20, 22 are wound. The rₕₜ and rₕₛ values are typically stored with the value for radius r_{c} in the ROM 78.

The processor 66 can then determine the sum of the Aₜ and Aₛ values to determine a value representative of the total tape pack area Aₜₒₜ for the tape cartridge 10 and compare that with a total tape pack area reference value A_{ref} for the tape cartridge to determine a damage condition of the magnetic tape 18. The total tape pack area reference value A_{ref} is a value representative of the total tape pack area for the tape cartridge that is typically obtained by running the process described above the first time the tape cartridge 10 is used. As is known, when a tape cartridge 10 is used for the first time, the tape drive deploys the tape 18 and detects that tape is not formatted. Formatting is carried out in the usual way and the tape drive is programmed to run the tape to obtain values for v, ωₜ and ωₛ from which it is able to determine the A_{ref} value. This value is then written to a portion of the tape 18 that will not be written over, for example, the area that is reserved for vendor data. Alternatively, or additionally, if the tape cartridge 10 is provided with a memory chip 76 (FIG. 3), the total tape pack area reference value A_{ref} can be stored on the memory chip.

The processor 66 can be programmed to carry out the damage condition comparison in a variety of ways. In one embodiment, the processor 66 is able to access stored threshold values and cause different outputs according to how the damage condition obtained from the comparison of the total tape pack area Aₜₒₜ with the total tape pack area reference value A_{ref} compares with the threshold values. For example, if the total tape pack area Aₜₒₜ is a value substantially equal to or is greater than the total tape pack area reference value A_{ref} by an amount not exceeding a first threshold value T₁, the processor 66 causes no output and allows continued use of the tape cartridge for data transfer operations. If the difference D between the total tape pack area value Aₜₒₜ is greater than the first threshold value T₁, the processor compares the difference between the difference D value with a second threshold value T₂, which is greater that the first threshold value T₁. If the difference D does not exceed the second threshold value T₂, the processor 66 causes a tape condition indication to be output to, for example, a display associated with the tape drive. This may be a message configured to indicate to a person responsible for the tape drive that the tape is damaged and a problem might soon occur. If the threshold value T₂ is exceeded, the processor 66 provides an output for preventing the writing of further data to the tape 18. Optionally, the difference D could be compared with a further threshold T₃ that is even greater than T₂. In that case, if the threshold value T₃ were exceeded, the processor 66 would provide an output causing the tape to be rejected and/or ejected from the tape drive.

The various tape conditions determined from the comparisons with the thresholds T₁, T₂, T₃ described above generally require that the tape packs, while possibly damaged, remain relatively ‘hard’. That is, there is little or no axial or circumferential slip of the tape layers relative to one another. If a tape pack is ‘soft’ there will be relative slippage between tape layers and this damage condition will show up when the total tape pack area Aₜₒₜ is less than the total tape pack area reference value A_{ref}. The total tape pack area Aₜₒₜ will go smaller than the total tape pack area reference value A_{ref} in these situations because when the tape layers slip, the resistance opposing rotation of the drive spindle motors is reduced and so the motors run faster. This results in a higher ω value for the r=v/ω relationship. Since the value of v obtained from the v=r·ω relationship at the capstan should be substantially unaffected by tape slippage, the result of an increased ω value will be a reduced r value that does not reflect the actual value. Once this erroneous value has been squared in the Aₜ=π(rₜ²−rₕₜ²) or Aₛ=π(rₛ²−rₕₛ²) relationship the result is a gross error that is easily detected. In order to avoid erroneous detections of tape slip resulting from minor inaccuracies in the detection process or minor changes in tape behaviour, it is preferable to a have threshold value T₄ that is less than the total tape pack area reference value A_{ref} and determine tape slippage if the value for the total tape pack area Aₜₒₜ is less than the total tape pack area reference value A_{ref} by an amount exceeding the threshold. Since tape slippage is an indication that tape failure is imminent, when tape slippage is detected the processor 66 preferably causes data transfer operations to cease and the tape cartridge 10 to be rejected.

Optionally, before determining that tape rejection is required when tape slippage is detected, the tape drive may first carry out one or more procedures intended to ‘harden’ the tape pack. The tape may be slipping due to damage that cannot be rectified, at least while the tape cartridge remains in the tape drive. However, a lack of tape pack hardness that results in tape slippage may be a non-permanent damage condition that could, for example, be due to use in another tape drive that is not functioning properly or to handling issues external to the tape drive. In such cases, it may be possible to re-establish a required degree of tape pack hardness without removing the tape from the tape drive by fast winding the tape forwards and then rewinding and attempting a reread. If subsequent damage condition monitoring indicates that the tape is no longer damaged (ie there is no slippage), normal operation can continue. However, if one or more attempts to re-establish tape pack hardness fail, as indicated by further detections of tape slippage, the tape cartridge is rejected.

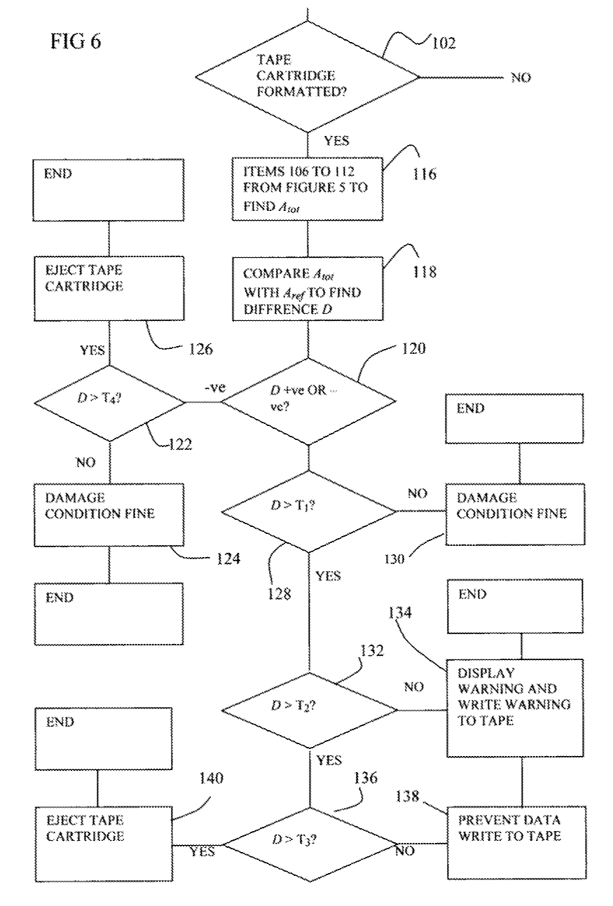

To better illustrate these possibilities some operating procedures will now be described with reference to the flow diagrams in FIGS. 5 and 6.

Referring to FIG. 5, following insertion of the tape cartridge 10 to a loaded position and deployment of the tape 18 at 100, data is read from the tape at 102 to determine whether the tape cartridge has been previously used. If it is determined at 102 that the tape has been used previously, the tape drive commences a procedure that is illustrated in FIG. 6 and, if not, the tape is formatted at 104. While formatting the tape, the processor 66 receives signals from the encoders 64, 72, 74. The signals from the encoders are stored in a suitable temporary memory location, such as a RAM 80 (FIG. 4) accessible by the processor 66 Then at 106 the processor 66 accesses the stored r_{c} value from the ROM 78 and uses that value together with a value ω_{c} derived from the signal from the encoder 64 stored in the RAM 80 to determine the velocity v of the tape 18 leaving the capstan 52. That value for velocity v is stored in the RAM 80. As an alternative to checking for formatting at 102, the processor 66 could simply check to see whether there is a total tape pack area reference value A_{ref} is stored in the tape cartridge and then proceed as illustrated in FIG. 5 according to whether a value is found.

Then at 108, the processor 66 determines the radius rₜ of the tape pack 20 and the radius rₛ of the tape pack 22 using the determined value of v stored in the ROM 78 and respective values of ωₜ and ωᵣ determined using the signals from the encoders 72, 74 that are stored in the RAM 80 in the relationships

v/ωₜ=rₜ

and

v/ωₛ=rₛ

The values determined as the radii rₜ and rₛ are then stored in the RAM 80.

Then at 110 the processor 66 determines respective area values Aₜ and Aₛ for the tape packs 20, 22 using the computed values of the radius rₜ and the radius rₛ stored in the RAM 80 in the relationships

Aₜ=π(rₜ²−rₕₜ²)

and

Aₛ=π(rₛ²=rₕₛ)

and stores those values in the RAM 80.

Then at 112 the processor 66 sums the computed Aₛ and Aₜ values to determine a value for total tape pack area Aₜₒₜ for the tape cartridge 10. Then at 114 the total tape pack area Aₜₒₜ is stored in the tape cartridge 10 by writing it as A_{ref} to an area on the tape 18 where it will not be overwritten, such as, for example, an area reserved for vendor data. If the tape cartridge has a memory chip 76, the A_{ref} value may alternatively, or additionally, be transmitted to the memory chip.

Referring to FIG. 6, at 102 when in the procedure illustrated by FIG. 5 the processor 66 has determined that the tape cartridge 10 has been previously used and there is a stored total tape pack area reference value A_{ref}, the processor 66 operates a procedure at 116 comprising items 106 to 112 from FIG. 5 to determine a value for the current total tape pack area Aₜₒₜ for the tape cartridge. The total tape pack area Aₜₒₜ value obtained is stored in the RAM 80. Then at 118 the processor 66 obtains the stored total tape pack area reference value A_{ref} from the tape cartridge 10 and compares this with the current value for the tape pack area Aₜₒₜ to determine a difference value D, which is held in the RAM 80.

At 120 the processor 66 determines whether the difference value D is positive or negative. If it is determined that the difference is negative (ie the total tape pack area Aₜₒₜ is less than the total tape pack area reference value A_{ref}), the processor checks for tape slippage at 122 by checking to see whether the difference is negative by an amount greater than a threshold value T₄. If the difference is not greater than the threshold T₄, at 124 the processor judges that there is no substantial tape slippage, the damage condition is considered fine and the tape condition detection procedure is terminated. If the comparison shows that the threshold T₄ has been exceeded, at 126 it is judged that there is tape slippage and the processor causes data transfer operations to be prevented and tape ejection.

If at 120 the difference D is determined as being positive, at 128 the processor 66 compares the difference value D with a first threshold value T₁ that is held in the ROM 78. If the difference value D is not greater than T₁, at 130 the tape damage condition is judged to be fine, or at least that there is no substantial tape damage and the tape condition detection procedure is terminated. The tape drive is then able to carry out data transfer operations normally. If the difference value D is judged to be greater than the threshold value T₁, the processor 66 compares the difference value D with a second threshold value T₂ at 132. The threshold value T₂ is held in the ROM 78 and is a higher value than the threshold value T₁. If the difference value D is found to be less than the threshold value T₂ then at 134 the processor 66 provides an output that causes a tape condition indication to be shown on a display associated with the tape drive and optionally writes warning data to an area of the tape that will not be overwritten or, where available, transmits warning data to the memory chip 76. However, if at 132 the difference value D is greater than the threshold value T₂, the difference value D is then compared with a threshold value T₃ at 136. The threshold value T₃ is stored in the ROM 78 and is greater than the threshold value T₂. If the difference value D is less than the threshold value T₃, then at 138 the processor 66 judges the damage condition to be more serious than at 126 and provides an output for preventing the writing of further data to the magnetic tape 18 in combination with the actions shown at 126. If the difference value D is greater than the threshold value T₃, then at 140 the processor 66 judges the damage condition to be critical and provides an output for causing the tape cartridge 10 to be rejected and/or ejected from the tape drive. Optionally the processor 66 additionally causes the actions shown at 134 to be taken prior to ejecting the tape cartridge 10.

In the foregoing description, the threshold values are described as being stored in a ROM. It will be appreciated that this is not essential and instead the threshold values may be calculated at each stage as a percentage of the total tape pack area reference value A_{ref}.

The procedures described with reference to FIGS. 5 and 6 take place as a part of the tape cartridge 10 loading process and allow various levels of action to be taken if the tape is judged to be damaged (including in the worst case tape cartridge ejection) before the tape drive commences data transfer operations on the tape. The FIG. 6 procedures may be additionally carried out at tape cartridge unload. When damage is detected during tape loading, it can be inferred that the damage occurred prior to loading, perhaps in a previous use in that tape drive or another tape drive or during handling between use. It will be appreciated if the procedures are run both at loading and unloading, if damage is detected during unloading that was not detected during tape loading, it is possible to infer the degradation took place by use in the tape drive. This information may be stored in a non-volatile memory, such as a flash memory, in the tape drive to provide a log showing a history of tape degradation that can be used to help assess whether the tape drive has a tendency to damage tape.

It will be understood that the total pack area of the tape 18 will vary in use due to thermal and hygroscopic expansion of the tape material. Calculations based on the properties of the materials that constitute magnetic tape show that over a 50° C. operating range, the worst case scenario is that the change in the total pack area due to these factors will be approximately 0.1%. Experiments with DAT160 cartridges have shown that in addition to changes due to environmental factors, even when the tape 18 remains undamaged, the ‘measurement’ values obtained will vary as the procedures do not allow for precision measurement. However, the variation has been found to be very small. For example, in tests with a DAT160 tape cartridge, a total tape pack area reference value A_{ref} of 1130 mm² was obtained. Subsequent tests on the undamaged tape produced values that varied from that by approximately 0.4%. The tape edge of approximately half the tape pack was then damaged and the tests made again. The total tape pack area was computed to be 1201 mm², which represents an area increase of approximately 6%. In normal use, it has been found that damage to the tape edge can cause the total tape pack area to far exceed this. At the point of actually seizing in the casing, values of around 1350 mm² have been obtained, which represents an area increase of approximately 20%. It will thus be appreciated that the differences between the values obtained in normal use while the tape remains substantially undamaged and the values obtained when there is tape edge damage will be sufficiently large to be readily detectable.

It will be understood that the described procedure of comparing the difference value D against several different threshold values and the actions taken in response to the judged damage condition is given purely by way of example and there is considerable scope for increasing or decreasing the level of sophistication of the detection process in terms of both the number of threshold values used and the actions taken. For example, there may be just one positive and one negative threshold value and any difference value obtained that exceeds one of the threshold values would result in immediate ejection of the tape cartridge from the tape drive.

It will be appreciated that the processes described can be implemented without providing any additional hardware in the tape drive since the components illustrated in FIG. 4 will typically already be present in a tape driving system of a tape drive. This allows implementation without increased cost and reliability concerns. Implementation can thus be by way of suitable computer instructions that can be in firmware or software, making it relatively easy to add the detection facility to new build equipment and ‘retrofit’ to existing equipment.

It will be understood that damage condition detection as described allows tape problems to be diagnosed. For example, if a log of damage detection results is maintained on the tape drive, it may be possible to infer that the damage occurring to tapes is not attributable to the tape drive. This may be particularly helpful in a tape library environment in which the tapes may be used in any one of several different tape drives according to drive availability at the time of user demand.

It will be understood that the processes described can also be applied to single reel tape cartridges such as those used for LTO and DLT formats in exactly the same way as described above for twin reel tape cartridges. It will be appreciated that when a single reel tape cartridge is loaded in a tape drive the free end of the tape is connected to a reel within the tape drive so that in use there are in effect twin tape reels.

It will be appreciated that in embodiments in which a tape condition indicator is displayed following detection that the tape is damaged, the display may comprise a message displayed on a screen illumination of one or more lights, an audible display, a printout and/or any other suitable known method for providing an audio and/or visual display.

In the described embodiment, the tape damage detection procedure includes determining a value representative of total tape pack area and comparing that with a reference total tape pack area value. This is not essential. For example, tape damage detection may be based on determining a value representative of a diameter or radius of a tape pack (both of which are representative of, or related, to the tape pack area) and comparing that with a reference value. The advantage of a total tape pack area based process as used in the embodiment is that the position of the tape when the measurements are made is not critical, whereas if a comparison of a diameter or radius value is to be made, it needs to be made at the same winding position of the tape and preferably when the tape pack on the tape reel from which the value is obtained is close to its maximum diameter.

It will be understood that the damage detection process is not limited to operation during tape loading and/or unloading. The process could be run substantially continuously or at regular intervals throughout the time in which the tape cartridge is loaded in the tape drive. It is envisaged that regular monitoring in this manner will better detect tape pack slipping problems.

In the description of the embodiment, reference is made to values being stored in ROM and RAM of the tape drive. It is to be understood that this is not to be taken as limiting and the data used for the damage detection may be stored in any convenient known manner and may, for example, be stored externally of the tape drive in an external memory.

It will be appreciated that the data processing that results in the damage determination may be performed by any suitable processing device and that, for example, the processing device may take the form of any circuitry, processor and/or chip, including, but not limited to microprocessors and field-programmable gate arrays.

In the embodiment, the signals from which the rotational speed values ω are derived are encoders. It will be understood that this is not essential and any sensor providing a signal suitable for deriving the required rotational speed values may be used. It will also be appreciated that while detecting the output speed of the motors driving the tape spindles provides a convenient means for obtaining the rotational speed values ω, the values may be obtained by other means. For example, optical sensors could be arranged to detect the rotational speed of the tape drive spindles or the tape reels themselves.

It will be understood that the invention includes a system for determining values representative of the tape pack area of a tape in a tape data transfer apparatus based on signals indicating speed of system components associated with tape movement and comparing the determined tape pack area value with a reference tape pack area value to obtain an indication of the condition of the tape. If the comparison indicates that the tape pack area value is greater than the tape pack area reference value, it can be judged that that there is damage to the edges of the tape and whether this is sufficient to require action to be taken or use of the tape can be continued. If the comparison indicates the tape pack area value is less than the tape pack area reference value, this indicates tape slippage and it can be judged whether this is sufficient to require action or use of the tape can be continued.

It will be understood that the invention can be applied to monitoring the condition of tape media generally, including magnetic and optical tape.

It will be understood that damage condition detection as described can be used to detect tape edge damage and loose packing of the tape packs before a critical error takes place. Furthermore, the detection procedures can be as a part of the tape loading and unloading procedures without adding to the procedure times.

It will be understood that the damage condition detection as described allows the possibility of rejection of a damaged tape cartridge at tape load time before any new data is transferred to it.

1. A tape data transfer apparatus operable to determine a tape damage condition of a tape of a tape cartridge received in the apparatus by determining a value representative of a tape pack size of the received tape and comparing said value representative of tape pack size with a tape pack size reference value, said reference value being read from said cartridge.

2. A tape data transfer apparatus as claimed in claim 1, operable to determine said value representative of tape pack size using respective speed indicative signals for at least two parts of the apparatus that move with said tape when said tape is moved relative to said tape cartridge by the apparatus.

3. A tape data transfer apparatus as claimed in claim 2, wherein one of said parts is a capstan.

4. A tape data transfer apparatus as claimed in claim 1, wherein said value representative of tape pack size is a value representative of tape pack area A that is computed using the relationship A=π(r²−rₕ²), where r is a value representative of a radius of said tape pack determined using said speed indicative signals and rₕ is a value representative of a radius of a hub of a tape reel on which the tape pack is wound.

5. A tape driving system for driving a tape cartridge received in a tape data transfer apparatus, said tape driving system comprising:
a rotatable tape engaging member having a first radially extending dimension;
a device for providing a signal indicative of a speed of rotation of said rotatable tape engaging member;
a rotatable tape reel engaging member;
a device for providing a signal indicative of a speed of rotation of said rotatable tape reel engaging member; and
a processing device, said processing device being operable to determine a tape pack area value of a tape pack carried by a tape reel of a said tape cartridge engaged by said rotatable tape reel engaging member based on a value representative of said first radially extending dimension, said signal indicative of a speed of rotation of said rotatable tape engaging member and said signal indicative of a speed of rotation of said rotatable tape reel engaging member and use said determined tape pack area value of the tape pack in determining a damage condition of the tape.

6. A tape driving system for a tape data transfer apparatus as claimed in claim 5, comprising:
a second rotatable tape reel engaging member; and
a device for providing a signal indicative of a speed of rotation of said second rotatable tape reel engaging member, said processing device being operable to determine said damage condition using said determined tape pack area value of said tape pack and a determined tape pack area value of a second tape pack that is carried by a second tape reel that is engaged by said second rotatable tape reel engaging member and to determine said tape pack area value representative of said second tape pack based on said value representative of said first radially extending dimension, said signal indicative of a speed of rotation of said rotatable tape engaging member and said signal indicative of a speed of rotation of said second rotatable tape reel engaging member.

7. A tape driving system for a tape data transfer apparatus as claimed in claim 6, wherein said processing device is operable to sum the respective determined tape pack area values of said tape packs to determine a total tape pack area value that is used in determining said damage condition.

8. A tape driving system as claimed in claim 7, wherein said processing device is operable to determine said damage condition using a difference value obtained by comparing said total tape pack area value with a reference value stored by said tape cartridge.

9. A tape driving system as claimed in claim 8, wherein said processing device is operable to determine said damage condition by comparing said difference value with at least one threshold value.

10. A method of detecting a condition of a tape of a tape cartridge received in a tape data transfer apparatus, the tape forming a tape pac on a tape reel reel in said data transfer apparatus and said method comprising determining a value related to a tape pack size of said tape pack and comparing said value with a reference value stored by said tape cartridge to determine a damage condition of the tape.

11. A method of detecting tape condition in a tape data transfer apparatus as claimed in claim 10, comprising using a value indicative of rotational speed of said tape reel and a value indicative of linear velocity of tape drawn from or winding onto said tape reel to determine a value representative of a radially extending dimension of said tape pack on said tape reel and using said determined value representative of a radially extending dimension and a reference value in determining a damage condition of the tape.

12. A method of detecting tape condition in a tape data transfer apparatus as claimed in claim 11, comprising using said value indicative of linear velocity and a value indicative rotational speed of a second tape reel carrying a second tape pack to determine a value representative of a radially extending dimension of said second tape pack, using respective said values representative of a radially extending dimension to determine respective area values for said tape packs and adding said area values to determine a total tape pack area value, said reference value being a reference total tape pack area value.

13. A method of detecting tape condition in a tape data transfer apparatus as claimed in claim 12, comprising comparing said reference value with said determined total tape pack area value to obtain a difference value and determining said damage condition of the tape by comparing said difference value with at least one threshold value.

14. A method as claimed in claim 10, comprising causing at least one of the following in response to determining the tape is damaged:
i) a tape condition indication to be displayed on a display device associated with the tape data transfer apparatus;
ii) a tape condition indication to be written to said tape;
iii) write prevention to be enabled to prevent writing of data to said tape;
iv) tape ejection from the tape data transfer apparatus; and
v) a tape rewind process.

15. A processor or data storage component having computer instructions stored therein that when executed operate to implement a method as claimed in claim 10.
